(19) United States
(12) Patent Application Publication
(10) Pub. No.: US 2025/0299448 A1
(43) Pub. Date: Sep. 25, 2025

(54) METHOD AND APPARATUS FOR GENERATING VIEWS OF THREE-DIMENSIONAL MODEL, ELECTRONIC DEVICE, AND STORAGE MEDIUM

(71) Applicants: Beijing Zitiao Network Technology Co., Ltd., Beijing (CN); Zhejiang University, HANGZHOU CITY (CN)

(72) Inventors: Bangbang YANG, Beijing (CN); Wenqi DONG, Beijing (CN); Lin MA, Beijing (CN); Yuewen MA, Beijing (CN); Zhaopeng CUI, Beijing (CN)

(21) Appl. No.: 19/090,145

(22) Filed: Mar. 25, 2025

(30) Foreign Application Priority Data
Mar. 25, 2024 (CN) 202410345959.2

(51) Int. Cl. G06T 17/30

(52) U.S. Cl. CPC G06T 17/30

(57) ABSTRACT

The present disclosure provides a method and an apparatus for generating views of a three-dimensional model, an electronic device, and a storage medium. The method for generating views of a three-dimensional model includes: obtaining a three-dimensional geometric model and a text description; and generating views of a target three-dimensional model based on the geometric model and the text description, wherein the target three-dimensional model has texture information and the target three-dimensional model conforms to the text description, a similarity between a contour of the target three-dimensional model and a contour of the geometric model is greater than a preset similarity, and the views of the target three-dimensional model include: views corresponding to first camera poses, the number of the first camera poses being one or more.

### CROSS-REFERENCE TO RELATED APPLICATION(S)

This application claims priority to Chinese Application No. 202410345959.2 filed in Mar. 25, 2024, the disclosures of which are incorporated herein by reference in their entities.

### FIELD

The present disclosure relates to the field of computer technologies, and in particular, to a method and an apparatus for generating views of a three-dimensional model, an electronic device, and a storage medium.

### SUMMARY

The present disclosure provides a method and an apparatus for generating views of a three-dimensional model, an electronic device, and a storage medium.

The following technical solutions are used in the present disclosure.

In some embodiments, the present disclosure provides a method for generating views of a three-dimensional model, including:
obtaining a three-dimensional geometric model and a text description; and
generating views of a target three-dimensional model based on the geometric model and the text description, where the target three-dimensional model has texture information and the target three-dimensional model conforms to the text description, a similarity between a contour of the target three-dimensional model and a contour of the geometric model is greater than a preset similarity, and the views of the target three-dimensional model include: views corresponding to first camera poses, the number of the first camera poses being one or more.

In some embodiments, the present disclosure provides an apparatus for generating views of a three-dimensional model, including:
an obtaining unit configured to obtain a three-dimensional geometric model and a text description; and
a control unit configured to generate views of a target three-dimensional model based on the geometric model and the text description,
where the target three-dimensional model has texture information and the target three-dimensional model conforms to the text description, a similarity between a contour of the target three-dimensional model and a contour of the geometric model is greater than a preset similarity, and the views of the target three-dimensional model include: views corresponding to first camera poses, the number of the first camera poses being one or more.

In some embodiments, the present disclosure provides an electronic device. The electronic device includes: at least one memory and at least one processor,
where the memory is configured to store program code, and the processor is configured to call the program code stored in the memory to perform the method described above.

In some embodiments, the present disclosure provides a computer-readable storage medium configured to store program code that, when executed by a processor, causes the processor to perform the method described above.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of a method for generating views of a three-dimensional model according to an embodiment of the present disclosure;

FIG. 2 is an effect diagram of a method for generating views of a three-dimensional model according to an embodiment of the present disclosure;

FIG. 3 is a schematic diagram of a method for generating views of a three-dimensional model according to an embodiment of the present disclosure;

FIG. 4 is a schematic diagram of changing a part of a three-dimensional model according to an embodiment of the present disclosure; and

FIG. 5 is a schematic diagram of a structure of an electronic device according to an embodiment of the present disclosure.

### DETAILED DESCRIPTION OF EMBODIMENTS

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose whether to provide the personal information to software or hardware based on the prompt information, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that meet the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifier “one” mentioned in the present disclosure is illustrative and not restrictive, and those skilled in the art should understand that unless the context clearly indicates otherwise, the modifier should be understood as “one or more”.

The names of messages or information exchanged between a plurality of apparatuses in the implementations of the present disclosure are used for illustrative purposes only, and are not used to limit the scope of these messages or information.

In the field of intelligent terminals, for example, virtual reality, mixed reality, or computer image fields, the creation of three-dimensional models with fine texture to enrich the virtual world is a very important aspect.

In the method for generating views of a three-dimensional model according to the embodiments of the present disclosure, control is applied to the contour of the target three-dimensional model through the geometric model, so that control is directly applied from the three-dimensional space to the modeling generation process. In addition, the generated geometric model for control applied may not be an elementary geometric model, and the contour of the target three-dimensional model may not closely fit the contour of the geometric model, but may have a certain degree of freedom.

The solutions provided in the embodiments of the present disclosure are described in detail below with reference to the accompanying drawings.

Three-dimensional models with texture are widely used in, for example, virtual reality, augmented reality, and other computer image application fields. In the related art, a three-dimensional (3D) model generation scheme driven by a single image or using a text description is proposed, i.e., generating a three-dimensional model through an image or generating a three-dimensional model through text. However, these techniques suffer from problems such as poor controllability and difficulty in interactive generation and modification (only allowing unidirectional generation of results, without the ability to perform partial quick modification and regeneration based on the generated results).

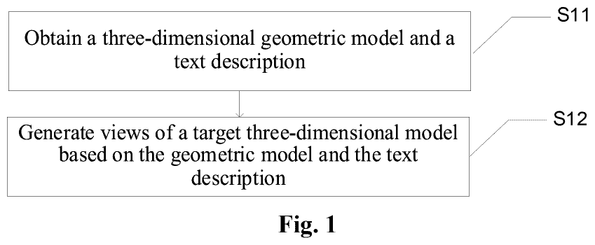

As shown in FIG. 1, which is a flowchart of a method for generating views of a three-dimensional model according to an embodiment of the present disclosure, the method includes the following steps.
S11: Obtain a three-dimensional geometric model and a text description.

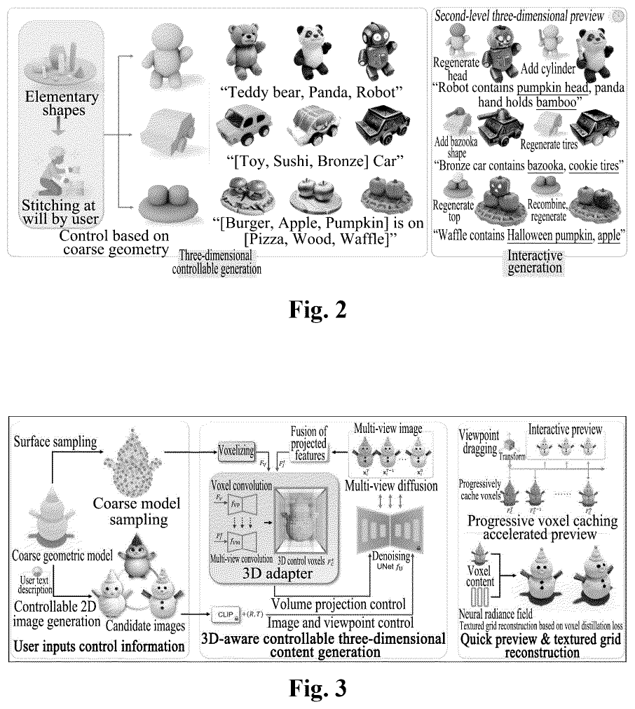

In some embodiments, the geometric model may be a geometric model built by a user. In some embodiments, the geometric model includes one or more non-elementary geometric shapes, or the geometric model is composed of one or more non-elementary geometric shapes. As shown on the left side of FIG. 2, the geometric model may be generated by user operations, and specifically may be a coarse geometric model (such as the three coarse geometric models obtained on the left side of FIG. 2) obtained by means of rotation, movement, and other stitching operations of a plurality of elementary geometric shapes (spheres, tetrahedrons, cuboids, and cylinders), which do not have texture information. As shown on the left side of FIG. 2, the text description is generated by the user, and the text description may be text that describes the type and/or composition of the target three-dimensional model to be generated, for example, “Teddy bear, Panda, Robot”, “[Toy, Sushi, Bronze] Car”, “[Burger, Apple, Pumpkin] is on [Pizza, Wood, Waffle]” as recorded in FIG. 2. It is noted that the number of the target three-dimensional models may be one or more, so that, as shown above, features of a plurality of target three-dimensional models may be described in a single text description and, in some embodiments, respective views of the plurality of target three-dimensional models will be generated based on the features of the plurality of target three-dimensional models that are described in the text description.
S12: Generate views of a target three-dimensional model based on the geometric model and the text description.

In some embodiments, the target three-dimensional model has texture information and the target three-dimensional model conforms to the text description; for example, the teddy bear, the panda, and the robot generated on the left side in FIG. 2 all have surface texture. The texture information of the target three-dimensional model will be displayed in the views of the target three-dimensional model, and parts in the texture information that correspond to definitions in the text description may conform to the text description. The geometric model is configured to use its rendered contour to directly control, in three dimensions, the overall contour of the target three-dimensional model, wherein a similarity between a contour of the target three-dimensional model and a contour of the geometric model is greater than a preset similarity, and may be less than 100% (and also less than 95%), and the geometric model defines the overall contour of the target three-dimensional model and the preset similarity is less than 100%, which is, for example, 80%, 85%, 90%, or the like. In this way, the contour of the generated target three-dimensional model has a certain degree of freedom and does not closely fit the shape of the geometric model given by the user, and the shapes of the views of the target three-dimensional model are not exactly the same as the shape of the geometric model. Instead, changes may be made to the shape of the geometric model based on the text description. In some embodiments, the overall contour of the target three-dimensional model is given by the geometric model and the target three-dimensional model conforms to the text description, and views of the target three-dimensional model are generated in step S12. The number of views of the target 3D model may be one or more. Optionally, the views of the target three-dimensional model include: views corresponding to first camera poses, the number of the first camera poses being one or more. Thus, the views of the target three-dimensional model may be views corresponding to a plurality of different first camera poses. For example, the first camera poses are 12 different camera poses. For a target three-dimensional model, views corresponding to the 12 different first camera poses are generated. The first camera pose describes the orientation and perspective when generating a view, and the 12 different first camera poses may represent orientations and perspectives around the target three-dimensional model, allowing for the generation of views from various perspectives around the circumference of the target three-dimensional model. In some embodiments, the geometric model and the text description are input into a multi-view generation model based on a diffusion model to generate views of the target three-dimensional model. In some embodiments, after obtaining the views of the target three-dimensional model, this method can also reconstruct the target three-dimensional model based on multi-view stereo (MVS) reconstruction, 3D Gaussian splatting, or other methods, and can generate the target three-dimensional model from the views of the target three-dimensional model, allowing it to be displayed in different forms according to user needs.

In the related art, the control is generated through pictures or text, which makes it impossible to apply control directly from the three-dimensional space to the model generation process. In addition, the controls applied during the model generation process are generally elementary geometric shapes (spheres, rectangles, cylinders, etc.), and there is a lack of approach that applies three-dimensional control of coarse shapes (non-elementary geometric shapes) to the generation of fine shapes, and at the same time, ensures that the diversity of the generation algorithm itself is not affected (i.e., that the generated model has a certain degree of freedom and does not closely fits the shape given by the user). In some embodiments of the present disclosure, by applying control to the contour of the target three-dimensional model through the geometric model, control is directly applied from the three-dimensional space to the modeling generation process. In addition, the generated (geometric model for) control applied is not an elementary geometric model, while the contour of the target three-dimensional model may not closely fit the contour of the geometric model, but may have a certain degree of freedom. The contour of the target three-dimensional model may not closely fit the contour of the geometric model, and may be less than 100%.

For example, given a coarse geometric model P and a text description y, a multi-view generation model f based on a diffusion model is used to predict Nᵥ (denoting the number of) images xᵢ corresponding to the same target three-dimensional model, i=1, 2, . . . , Nᵥ, with Nᵥ being greater than 1, which may be, for example, 12. The various images xᵢ correspond to different first camera poses cᵢ, i=1, 2, . . . , Nᵥ, and the multi-view generation model f is defined as x_{(i:N}_{ᵥ}₎=∫(P,y,c_{(i:N}_{ᵥ}₎) Unlike the conventional 2D diffusion, multi-view diffusion performs denoising iteration processes synchronously on images from different perspectives corresponding to all the first camera poses, which allows for the integration of cross-view correlations with view-dependent self-attention or control volume pixels (voxels). In order to simplify the preparation process for the geometric model, the user is allowed to assemble elementary geometric shapes as input through simple operations, such as translation, scaling, and rotation, to obtain the geometric model without the need for more complex modeling processes.

In some embodiments of the present disclosure, generating views of the target three-dimensional model that conforms to the text description and has texture includes: generating geometric feature voxels of the geometric model; determining a target candidate image based on the geometric model and the text description; and obtaining the views of the target three-dimensional model based on the geometric feature voxels and features of the target candidate image.

In some embodiments, the present disclosure adopts dual-path condition preprocessing. As shown in FIG. 3, on one path, geometric feature voxels Fᵥ are generated by means of a geometric model (coarse geometric model), and on the other path, a target candidate image is generated based on the rendered contour of the geometric model and a text description. Specifically, candidate images may be generated based on the geometric model and the text description; and in response to input information, a target candidate image is determined based on the input information. The input information may be the selection information from the user, and there may be a plurality of candidate images, and the user selects one from them as the target candidate image. In the process of generating views of the target three-dimensional model, iterations can be performed on a noisy image to obtain views of the target three-dimensional model. For example, through the Diffusion model, iterations are performed starting from a pure Gaussian noise image for continuous denoising to obtain views of the target three-dimensional model. Specifically, when generating the target candidate image, a plurality of candidate images may be first generated, and then a target candidate image is selected by the user from the candidate images. In this embodiment, 3D control is performed on the target three-dimensional model by means of the geometric feature voxels Fᵥ, and 2D control is applied by means of the target candidate image. That is, control is applied from both 3D and 2D dimensions to the generation of views of the target three-dimensional model. This ensures three-dimensional consistency of the views of the target three-dimensional model across different first camera poses, thus avoiding a situation where the view from one angle conforms to the candidate image while the view from another angle shows a large deviation.

In some embodiments of the present disclosure, generating the geometric feature voxels of the geometric model includes: performing sampling at sampling points on a surface of the geometric model, and voxelizing the sampling points of the geometric model to populate a zero-initialized occupancy grid to obtain the geometric feature voxels. In some embodiments, as shown in FIG. 3, Nₛ sampling points are sampled on the surface of the (coarse) geometric model, with the sampling points being used for the generation of the geometric feature voxels Fᵥ. Specifically, the sampling points are voxelized to populate the zero-initialized occupancy grid, where, for any grid in the occupancy grid, the grid is assigned a value of 1 if any sampling point is contained therein, and a value of 0 if no sampling point is contained therein. The populated occupancy grids are used as the geometric feature voxels Fᵥ.

In some embodiments of the present disclosure, denoising iteration is performed on a noisy image based on the geometric feature voxels and the features of the target image to obtain the views of the target three-dimensional model, wherein the following steps are performed during each denoising iteration: performing back-projection and fusion on a target image to obtain multi-view feature voxels; inputting the geometric feature voxels and the multi-view feature voxels into a 3D adapter to generate 3D control voxels; and obtaining output images of the current denoising iteration based on the 3D control voxels, the target image, the features of the target candidate image, and the first camera poses, wherein the target image is an output image of the last denoising iteration process; when denoising iteration is performed for the first time, the target image is the noisy image; and the number of the output images is a plurality, each matching a respective one of the plurality of first camera poses.

In some embodiments, as shown in the middle boxed portion of FIG. 3, which illustrates a process of denoising iteration, when performing the denoising iteration, the process starts the denoising iteration from a noisy image, and gradually generates the finally obtained target three-dimensional model. When performing the denoising iteration, each denoising iteration outputs a plurality of views corresponding respectively to the plurality of first camera poses as output images. Thus, there are a plurality of views (of the target three-dimensional model) in a target image (which is a respective output image x^{t}_{(i:N)} from the previous denoising iteration that corresponds to each of the plurality of different first camera poses). Multi-view feature voxels Fᵢ^{t} are constructed by back-projection and fusion of these multi-view images (thus, the multi-view feature voxels are different in each denoising iteration process, and the number thereof is related to the number of denoising iterations), such that the features of the views of the target three-dimensional model in different first camera poses during the iteration process are fused in the view feature voxels Fᵢ^{t}, thus allowing the various views of the finally generated target three-dimensional model to have a good three-dimensional consistency. The 3D control voxels F_{c}^{t}, the target image, the features of the target candidate image, and the first camera poses all have impact on the output images of this iteration, wherein the superscript t represents the timestamp of the iteration, the output images of each iteration are Xᵢ^{t}, and the number of the 3D control voxels is the same as the number of iterations. In FIG. 3, a total of T iterations are performed, so there are a total of T 3D control voxels, and a total of T output images of Xᵢ^{T}, Xᵢ^{T-1} to Xᵢ⁰ are obtained. For each iteration, there may be a plurality of output images that correspond to different first camera poses, or the step of denoising described above may be repeated Nᵥ times for Nᵥ different first camera poses in each iteration. By means of a diffusion UNet model, views of the target three-dimensional model that correspond to the first camera poses can be generated. The features of the candidate target image can be embedded by means of a CLIP (contrastive language-image pre-training) model.

In some embodiments of the present disclosure, obtaining output images of the current denoising iteration based on the 3D control voxels, the target image, the features of the target candidate image, and the first camera poses includes: projecting the 3D control voxels to align with the target image to obtain a 2D feature map; and inputting the 2D feature map, the features of the target candidate image, and the first camera poses into a diffusion model to obtain the output images of the current denoising iteration.

In some embodiments, F_{c}^{t} is projected to align with the target image (xᵢ^{t}, t representing the timestamp of the iteration) of the current denoising iteration process to obtain a 2D feature map (with depth attention), and the 2D feature map, the features (embedded by the CLIP model) of the target candidate image, and the first camera poses are input to the diffusion UNet model to obtain the output images.

In some embodiments of the present disclosure, inputting the geometric feature voxels and the multi-view feature voxels into the 3D adapter to generate the 3D control voxels includes: the 3D adapter performing 3D convolution on the geometric feature voxels to obtain outputs of intermediate layers, and the 3D adapter performing 3D convolution on the multi-view feature voxels and adding the outputs of the intermediate layers in a layered manner to the process of performing 3D convolution on the multi-view feature voxels to obtain the 3D control voxels.

In some embodiments, as shown in FIG. 3, in the 3D adapter, it obtains the input geometric feature voxels F_{V} and multi-view feature voxels Fᵢ^{t}, then performs 3D convolution (in which a 3D UNet f_{VM} can be used) on the geometric feature voxels F_{V}, with the outputs of the various intermediate layers during the 3D convolution being recorded, and then performs 3D convolution (in which a 3D UNet f_{VP} can be used) on the multi-view feature voxels Fᵢ^{t} and adds the recorded inputs of the intermediate layers, so as to generate the final 3D control voxels F_{c}^{t}.

In some embodiments of the present disclosure, during a pre-training process for the 3D adapter, a training image and a sampling point of a training geometric model are selected as a training sample, Gaussian noise is added to the training image, and the added noise is predicted through a constraint network, and the difference between the input Gaussian noise and the predicted noise is reduced by adjusting the 3D adapter. In some embodiments, training (coarse) geometric models are prepared in advance and, during the pre-training phase, each training model (an object model containing a large amount of texture) is pre-processed into views from a plurality of perspectives and sampling points, wherein the sampling points are obtained through uniform sampling on the surface of the training geometric model. For each training step, B views and the corresponding sampling points are randomly selected, as well as B timestamps with Gaussian noise ε^{(1:B)}·N∈(0, 1). During the training process, the added noise is predicted through a constraint network:

$${min}_{θ} {𝔼}_{t , {x}_{( 1 : {N}_{υ} )} , {ϵ}_{( 1 : {N}_{υ} )}} ‖ {ϵ}_{i} - {ϵ}_{θ} ( {x}_{i}^{t} , t , c ( I , {F}_{C}^{t} . {c}_{i} ) ) ‖$$

where ε_{θ} is the noise predicted by the model, C(I, F_{c}^{t}, cᵢ) is the conditional embedding of the candidate image I, F_{c}^{t} is the 3D control voxel, and cᵢ denotes the camera perspective, and by constraining the network used, the predicted added noise and the actual added noise are minimized. In some embodiments, during the pre-training process, the 3D adapter uses zero convolution to convolve geometric feature voxels of the training geometric model, while freezing other layers of the 3D adapter. During the training process, the 3D adapter uses zero convolution when convolving the geometric feature voxels and freezes the other layers, which allows manipulation of the intensity of control during the generation process.

In the related art, after generating the three-dimensional model or its views, it is often impossible to make fine local editing and modifications, or modifications are supported but it takes a long time to preview the modified effect, which makes it less practical in actual interactions. Therefore, there is a need to allow the user to make local modifications and to quickly preview the modified results.

In some embodiments of the present disclosure, after generating the views of the target three-dimensional model based on the geometric model and the text description, the method further includes: changing a first part of the text description; performing a modification operation on a second part of the geometric model that corresponds to the first part to obtain the updated geometric model; updating the target candidate image based on a second part of the updated geometric model and the first part; updating the 3D control voxels based on a feature mask of the second part of the updated geometric model to obtain the updated 3D control voxels; and re-performing the denoising iteration based on the updated 3D control voxels, features of an updated target candidate image, and the first camera poses to obtain views of an updated target three-dimensional model. This situation corresponds to the situation where the user modifies the first part in the text description and modifies the corresponding second part in the geometric model. The first part is part of the text description rather than all of it, and the second part is part of the geometric model rather than all of it. Modifications can be made either by means of changes or by additions.

In some embodiments of the present disclosure, after generating the views of the target three-dimensional model based on the geometric model and the text description, the method further includes: changing a first part of the text description; updating the target candidate image based on a second part of the geometric model that corresponds to the first part and the first part; updating the 3D control voxels based on a feature mask of the second part of the geometric model to obtain the updated 3D control voxels; and re-performing the denoising iteration based on the updated 3D control voxels, features of an updated target candidate image, and the first camera poses to obtain views of an updated target three-dimensional model. This situation corresponds to the situation where the user modifies the first part in the text description but does not modify the geometric model.

In some embodiments of the present disclosure, after generating the views of the target three-dimensional model based on the geometric model and the text description, the method further includes: performing a modification operation on a second part of the geometric model to obtain the updated geometric model; updating the target candidate image based on a second part of the updated geometric model; updating the 3D control voxels based on a feature mask of the second part of the updated geometric model to obtain the updated 3D control voxels; and re-performing the denoising iteration based on the updated 3D control voxels, features of an updated target candidate image, and the first camera poses to obtain views of an updated target three-dimensional model. This situation corresponds to the situation where the user does not modify the text description and the user modifies the second part in the geometric model.

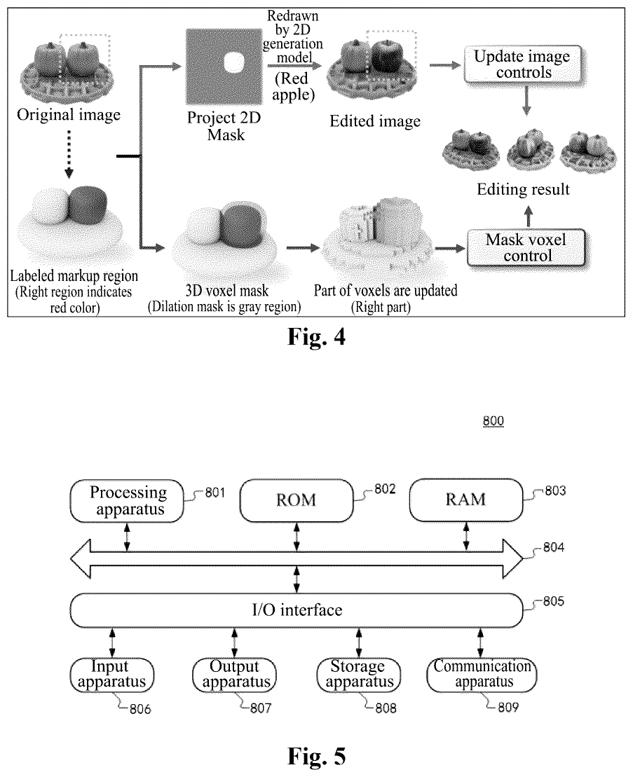

In some embodiments, the present disclosure proposes an interactive generation technique that utilizes the combinability of the geometric model itself to enable partial editing and reuse the previous 3D control voxels for interactive previewing. Specifically, using FIG. 4 as an example, in this embodiment, a pumpkin can be regenerated into a red apple by specifying a sphere on the plate. This is equivalent to changing the pumpkin in the text description to a red apple, and corresponding modifications can be made to the second part in the geometric model; for example, the dimensions of the second part, which corresponds to the pumpkin, can be changed. In this embodiment, regeneration of views is performed with both 3D control and 2D control as control conditions. The user can specify a piece from the geometric model for modification and regenerate the content of this piece; for example, as shown in the lower left corner of FIG. 4, the portion to the right of the labeled markup region is changed to red to obtain the updated geometric model. For the 2D control, in this embodiment, a 2D mask (feature mask) is constructed, which is constructed by projecting a mask coarse model (which represents the second part) onto the desired original image (the target candidate image), and a diffusion-based regeneration of the target candidate image (the edited image in FIG. 4) is then performed. This process updates only the part of the target candidate image that corresponds to the second part, and then uses the updated target candidate image as the image condition in the denoising iteration process. For the 3D control, in this embodiment, a three-dimensional voxel mask may be constructed by slightly enlarging the mask coarse model, wherein the slightly enlarged mask coarse model is the feature mask M of the second part; for example, the slightly enlarged mask coarse model is made to be larger than the second part by a preset percentage (e.g., 2%, 3%, or 5%), in order to ensure seamless fusion of the newly generated content. Then, some of the voxels of the geometric model are updated. In this embodiment, the 3D control voxels of the previous denoising iteration process are updated to obtain the updated 3D control voxels. Specifically, for the 3D control voxels corresponding to the unmodified part of the geometric model, the previous 3D control voxels are still used, and for the 3D control voxels corresponding to the second part of the geometric model, the 3D control voxels recalculated based on the updated geometric model are used. More specifically, the following formula may be used to calculate the updated 3D control voxels:

$${\hat{F}}_{C}^{t} = ( 1 - M ) {F}_{C}^{t} + M {\tilde{F}}_{C}^{t}$$

where the left side of the equation is the updated 3D control voxel, F_{c}^{t} is a 3D control voxel corresponding to the iteration timestamp t during the previous calculation of the views of the target three-dimensional model, and \tilde{F}_{C}^{t} is a 3D control voxel corresponding to the timestamp t that is calculated based on the updated geometric model. During the calculation, it is possible to recalculate only the 3D control voxels corresponding to the second part, while the other parts directly use the previous 3D control voxels. The amount of calculation is reduced by fusing the previous 3D control voxels with the updated 3D control voxel that is updated at t. The denoising iteration is re-performed based on the updated 3D control voxels, features of an updated target candidate image, and the first camera poses to obtain views of an updated target three-dimensional model. In this process, because of the 2D and 3D control, it is possible to precisely edit and modify local parts of the target candidate image, thus correspondingly modifying local parts of the views of the target three-dimensional model while keeping the other parts unchanged. As shown in FIG. 4, in the editing result, only the part corresponding to the first part or the second part is updated, while the other parts remain unchanged. The right side of FIG. 2 also shows some applications of this embodiment. For example, in the top, middle, and bottom portions of the right side of FIG. 2, the head has been modified, a cylinder has been added, a bazooka shape has been added, a tire has been changed, the top has been changed, and the top has been deleted. The views of the target three-dimensional model will be updated based on the updated geometric model. It should be noted that when updating the geometric model, the text description can also be updated. An updated target candidate image will be generated based on the updated geometric model and the updated text description, and then the rest of the steps will be performed (with the rest of the steps remaining unchanged) in order to regenerate the views of the target three-dimensional model.

In some embodiments of the present disclosure, the 3D control voxels during the denoising iteration are cached; and the method further includes: in response to an event of obtaining a view of the target three-dimensional model that corresponds to a second camera pose, performing denoising iteration on the noisy image using the second camera pose and the 3D control voxels cached to obtain the view of the target three-dimensional model that corresponds to the second camera pose.

In some embodiments, the generated views of the target three-dimensional model are views in the first camera poses. In some situations, the user needs to view other views of the target three-dimensional model in different camera poses than the first camera poses; for example, the user may drag the geometric model to determine a second camera pose that needs to be viewed, wherein the second camera pose may correspond to the current pose of the geometric model. When generating a preview view, if the user is required to wait for a long period of time, a degradation of the user experience will be caused. In other embodiments, after the geometric model is modified, there is also a need to see the view of the modified target three-dimensional model within a short period of time, and thus there is a need to enable a preview of the view from any perspective within a few seconds. Thus, in some embodiments of the present disclosure, as shown in the upper right corner (progressive voxel caching accelerated preview) of FIG. 3, when previewing the view, a second camera pose is determined based on a perspective selected by the user, which may differ from the first camera poses. The denoising iteration process is then re-performed using the second camera pose and the most recently cached 3D control voxels to obtain a view of the target three-dimensional model that corresponds to the second camera pose. Since there is no need to rerun the 3D adapter, the views for each iteration step can be quickly decoded during the denoising iteration, thus allowing for the generation of a view of the target three-dimensional model in the second camera pose in just a few seconds.

In some embodiments of the present disclosure, the method further includes: generating the target three-dimensional model using a neural radiance field based on the views of the target three-dimensional model, wherein gradient information generated based on the 3D control voxels is embedded in a backpropagation process for reconstruction of the neural radiance field.

In some embodiments, the target three-dimensional model may be generated based on the views of the target three-dimensional model to enable reconstruction of the grid model with texture for subsequent applications. Specifically, the reconstruction of the target three-dimensional model may be performed using an NeRF (neural radiance field), wherein the NeRF (neural radiance field) is a novel three-dimensional model representation approach that uses a continuous 3D radiance field to represent the reconstructed model. When rendering such a three-dimensional model to 2D images, sampling points (calculated through camera parameters) of the outgoing rays from the image pixels are input, and the final pixel values are obtained through volume rendering integration. In the reconstruction phase, the user needs to input images from multiple perspectives as well as camera parameters. The model is reconstructed by supervising the pixel values of the volume rendering and the pixel values of the actual captured image and updating the model parameters using continuous gradient backpropagation. However, in the related art, reconstruction using the generated views in multiple perspectives is unsatisfactory and may produce unstable model reconstruction results due to the small number of perspectives. Therefore, in some embodiments of the present disclosure, the 3D control voxel F_{c}^{t} is used as auxiliary supervision when performing the reconstruction of the target three-dimensional model to improve the quality of the three-dimensional reconstruction. Specifically, in some embodiments, during the training process, gradient information from the 3D control voxels is embedded in a backpropagation process for reconstruction of the neural radiance field. The algorithm for the gradient information thereof may be as follows:

$${Δ}_{x} {L}_{V - SDS} = w ( t ) ( {ϵ}_{θ} ( {x}_{t} , t , c ( I , {F}_{C}^{t} , c ) ) - ϵ )$$

where the left side of the equation is the gradient information, w(t) denotes the weight of the denoising iteration corresponding to timestamp t, ε_{θ} is the predicted noise, e is the added noise, and c(I, F_{c}^{t}, c) is the conditional embedding of the candidate image I, with c denoting the camera pose. The reconstruction of the target three-dimensional model is supervised through 3D control voxels, thereby obtaining a better quality of grid reconstruction.

In some embodiments of the present disclosure, the generation of a target three-dimensional model based on a coarse geometric model allows the user to build a coarse geometric model with elementary geometric shapes and directly control the generation process for a fine three-dimensional model with texture.

In some embodiments of the present disclosure, a combination with three-dimensional modeling software is possible, which enables the user to build a coarse geometric model while previewing the effect of 3D generation, and also allows the user to fix other regions on the basis of the existing geometric model and regenerate the content of a specified region, thereby realizing local rapid generative editing.

In some embodiments of the present disclosure, by caching 3D control voxels, when the user is dragging the viewpoint to observe the geometric model, views of the target three-dimensional model with corresponding perspectives can be quickly generated.

In some embodiments of the present disclosure, the loss function of the reconstruction is constructed based on the distillation of 3D control voxels to effectively improve the reconstruction quality of the textured grid.

The present disclosure further provides an apparatus for generating views of a three-dimensional model, including:
an obtaining unit configured to obtain a three-dimensional geometric model and a text description; and
a control unit configured to generate views of a target three-dimensional model based on the geometric model and the text description,
where the geometric model is a non-elementary geometric shape, and a similarity between a contour of the target three-dimensional model and a contour of the geometric model is greater than a preset similarity, and the views of the target three-dimensional model include: views corresponding to first camera poses, the number of the first camera poses being one or more.

In some embodiments, generating views of the target three-dimensional model that conforms to the text description and has texture based on the geometric model includes: generating geometric feature voxels of the geometric model; determining a target candidate image based on the geometric model and the text description; and obtaining the views of the target three-dimensional model based on the geometric feature voxels and features of the target candidate image.

In some embodiments, determining the target candidate image based on the geometric model and the text description includes: generating candidate images based on the geometric model and the text description; and determining, in response to input information, the target candidate image based on the input information.

In some embodiments, generating the geometric feature voxels of the geometric model includes: performing sampling at sampling points on a surface of the geometric model, and voxelizing the sampling points of the geometric model to populate a zero-initialized occupancy grid to obtain the geometric feature voxels.

In some embodiments, denoising iteration is performed on a noisy image based on the geometric feature voxels and the features of the target image to obtain the views of the target three-dimensional model, wherein the following steps are performed during each denoising iteration: performing back-projection and fusion on a target image to obtain multi-view feature voxels; inputting the geometric feature voxels and the multi-view feature voxels into a 3D adapter to generate 3D control voxels; and obtaining output images of the current denoising iteration based on the 3D control voxels, the target image, the features of the target candidate image, and the first camera poses, wherein the target image is an output image of the last denoising iteration process; when denoising iteration is performed for the first time, the target image is the noisy image; and the number of the output images is a plurality, each matching a respective one of the plurality of first camera poses.

In some embodiments, obtaining output images of the current denoising iteration based on the 3D control voxels, the target image, the features of the target candidate image, and the first camera poses includes: projecting the 3D control voxels to align with the target image to obtain a 2D feature map; and inputting the 2D feature map, the features of the target candidate image, and the first camera poses into a diffusion model to obtain the output images of the current denoising iteration.

In some embodiments, inputting the geometric feature voxels and the multi-view feature voxels into the 3D adapter to generate the 3D control voxels includes: the 3D adapter performing 3D convolution on the geometric feature voxels to obtain outputs of intermediate layers, and the 3D adapter performing 3D convolution on the multi-view feature voxels and adding the outputs of the intermediate layers in a layered manner to the process of performing 3D convolution on the multi-view feature voxels to obtain the 3D control voxels.

In some embodiments, the 3D adapter is pre-trained in advance, and one or both of the following are met: during a pre-training process for the 3D adapter, a training image and a sampling point of a training geometric model are selected as a training sample, Gaussian noise is added to the training image, and the added noise is predicted through a constraint network; and
during the pre-training process, the 3D adapter uses zero convolution to convolve geometric feature voxels of the training geometric model, while freezing other layers of the 3D adapter.

In some embodiments, after generating views of a target three-dimensional model based on the geometric model and the text description, the control unit is further configured to: change a first part of the text description; perform a modification operation on a second part of the geometric model that corresponds to the first part to obtain the updated geometric model; update the target candidate image based on a second part of the updated geometric model and the first part; update the 3D control voxels based on a feature mask of the second part of the updated geometric model to obtain the updated 3D control voxels; and re-perform the denoising iteration based on the updated 3D control voxels, features of an updated target candidate image, and the first camera poses to obtain views of an updated target three-dimensional model;

In some embodiments, after generating views of a target three-dimensional model based on the geometric model and the text description, the control unit is further configured to: change a first part of the text description; update the target candidate image based on a second part of the geometric model that corresponds to the first part and the first part; update the 3D control voxels based on a feature mask of the second part of the geometric model to obtain the updated 3D control voxels; and re-perform the denoising iteration based on the updated 3D control voxels, features of an updated target candidate image, and the first camera poses to obtain views of an updated target three-dimensional model.

After generating views of a target three-dimensional model based on the geometric model and the text description, the control unit is further configured to: perform a modification operation on a second part of the geometric model to obtain the updated geometric model; update the target candidate image based on a second part of the updated geometric model; update the 3D control voxels based on a feature mask of the second part of the updated geometric model to obtain the updated 3D control voxels; and re-perform the denoising iteration based on the updated 3D control voxels, features of an updated target candidate image, and the first camera poses to obtain views of an updated target three-dimensional model.

In some embodiments, the 3D control voxels during the denoising iteration are cached; and the control unit is further configured to: in response to an event of obtaining a view of the target three-dimensional model that corresponds to a second camera pose, perform denoising iteration on the noisy image using the second camera pose and the 3D control voxels cached to obtain the view of the target three-dimensional model that corresponds to the second camera pose.

In some embodiments, the control unit is further configured to generate the target three-dimensional model using a neural radiance field based on the views of the target three-dimensional model, wherein gradient information generated based on the 3D control voxels is embedded in a backpropagation process for reconstruction of the neural radiance field.

The apparatus embodiment is substantially corresponding to the method embodiment, and therefore for a related part, reference may be made to the descriptions of the part in the method embodiment. The apparatus embodiment described above is merely illustrative. The modules illustrated as separate modules may be or may not be separate. Some or all of the modules may be selected according to actual needs to achieve the objectives of the solutions of the embodiments, which can be understood and implemented by those of ordinary skill in the art without involving any inventive effort.

The method and apparatus of the present disclosure have been described above based on the embodiments and application cases. In addition, the present disclosure further provides an electronic device and a computer-readable storage medium. The electronic device and the computer-readable storage medium are described below.

Referring to FIG. 5 below, there is shown a schematic diagram of a structure of an electronic device (such as a terminal device or a server) 800 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in the figure is merely an example, and shall not impose any limitation on the function and scope of use of the embodiments of the present disclosure.

The electronic device 800 may include a processing apparatus (e.g., a central processing unit, a graphics processing unit, etc.) 801 that may perform a variety of appropriate actions and processing in accordance with a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although the figure shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, wherein the computer program includes program code for performing the method shown in the flowchart. In such an embodiment, the computer program may be downloaded from a network through the communication apparatus 809 and installed, installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs, and the one or more programs, when executed by the electronic device, cause the electronic device to perform the above method according to the present disclosure.

The computer program code for performing the operations in the present disclosure may be written in one or more programming languages or a combination thereof, wherein the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, a method for generating views of a three-dimensional model is provided. The method includes:
obtaining a three-dimensional geometric model and a text description; and
generating views of a target three-dimensional model based on the geometric model and the text description,
where the target three-dimensional model has texture information and the target three-dimensional model conforms to the text description, a similarity between a contour of the target three-dimensional model and a contour of the geometric model is greater than a preset similarity, and the views of the target three-dimensional model include: views corresponding to first camera poses, the number of the first camera poses being one or more.

According to one or more embodiments of the present disclosure, a method for generating a three-dimensional model is provided, wherein generating views of the target three-dimensional model that conforms to the text description and has texture based on the geometric model includes:
generating geometric feature voxels of the geometric model;
determining a target candidate image based on the geometric model and the text description; and
obtaining the views of the target three-dimensional model based on the geometric feature voxels and features of the target candidate image.

According to one or more embodiments of the present disclosure, a method for generating views of a three-dimensional model is provided, where
determining the target candidate image based on the geometric model and the text description includes: generating candidate images based on the geometric model and the text description; and determining, in response to input information, the target candidate image based on the input information; and/or
generating the geometric feature voxels of the geometric model includes: performing sampling at sampling points on a surface of the geometric model, and voxelizing the sampling points of the geometric model to populate a zero-initialized occupancy grid to obtain the geometric feature voxels;
and/or performing denoising iteration on a noisy image based on the geometric feature voxels and the features of the target image to obtain the views of the target three-dimensional model, wherein the following steps are performed during each denoising iteration:
performing back-projection and fusion on a target image to obtain multi-view feature voxels;
inputting the geometric feature voxels and the multi-view feature voxels into a 3D adapter to generate 3D control voxels; and
obtaining output images of the current denoising iteration based on the 3D control voxels, the target image, the features of the target candidate image, and the first camera poses,
where the target image is an output image of the last denoising iteration process; when denoising iteration is performed for the first time, the target image is the noisy image; and the number of the output images is a plurality, each matching a respective one of the plurality of first camera poses.

According to one or more embodiments of the present disclosure, a method for generating views of a three-dimensional model is provided, wherein obtaining output images of the current denoising iteration based on the 3D control voxels, the target image, the features of the target candidate image, and the first camera poses includes: projecting the 3D control voxels to align with the target image to obtain a 2D feature map; and inputting the 2D feature map, the features of the target candidate image, and the first camera poses into a diffusion model to obtain the output images of the current denoising iteration;
and/or
inputting the geometric feature voxels and the multi-view feature voxels into the 3D adapter to generate the 3D control voxels includes: the 3D adapter performing 3D convolution on the geometric feature voxels to obtain outputs of intermediate layers, and the 3D adapter performing 3D convolution on the multi-view feature voxels and adding the outputs of the intermediate layers in a layered manner to the process of performing 3D convolution on the multi-view feature voxels to obtain the 3D control voxels.

According to one or more embodiments of the present disclosure, a method for generating views of a three-dimensional model is provided, wherein the 3D adapter is pre-trained in advance, and one or both of the following are met:
during a pre-training process for the 3D adapter, a training image and a sampling point of a training geometric model are selected as a training sample, Gaussian noise is added to the training image, and the added noise is predicted through a constraint network; and
during the pre-training process, the 3D adapter uses zero convolution to convolve geometric feature voxels of the training geometric model, while freezing other layers of the 3D adapter.

According to one or more embodiments of the present disclosure, a method for generating views of a three-dimensional model is provided, wherein after generating the views of the target three-dimensional model based on the geometric model and the text description, the method further includes:
changing a first part of the text description;
performing a modification operation on a second part of the geometric model that corresponds to the first part to obtain the updated geometric model;
updating the target candidate image based on a second part of the updated geometric model and the first part;
updating the 3D control voxels based on a feature mask of the second part of the updated geometric model to obtain the updated 3D control voxels; and
re-performing the denoising iteration based on the updated 3D control voxels, features of an updated target candidate image, and the first camera poses to obtain views of an updated target three-dimensional model;
or
changing a first part of the text description;
updating the target candidate image based on a second part of the geometric model that corresponds to the first part and the first part;
updating the 3D control voxels based on a feature mask of the second part of the geometric model to obtain the updated 3D control voxels; and
re-performing the denoising iteration based on the updated 3D control voxels, features of an updated target candidate image, and the first camera poses to obtain views of an updated target three-dimensional model;
or
performing a modification operation on a second part of the geometric model to obtain the updated geometric model;
updating the target candidate image based on a second part of the updated geometric model;
updating the 3D control voxels based on a feature mask of the second part of the updated geometric model to obtain the updated 3D control voxels; and
re-performing the denoising iteration based on the updated 3D control voxels, features of an updated target candidate image, and the first camera poses to obtain views of an updated target three-dimensional model.

According to one or more embodiments of the present disclosure, a method for generating views of a three-dimensional model is provided, wherein the 3D control voxels during the denoising iteration are cached; and
the method further includes: in response to an event of obtaining a view of the target three-dimensional model that corresponds to a second camera pose, performing denoising iteration on the noisy image using the second camera pose and the 3D control voxels cached to obtain the view of the target three-dimensional model that corresponds to the second camera pose.

According to one or more embodiments of the present disclosure, a method for generating views of a three-dimensional model is provided. The method further includes:
generating the target three-dimensional model using a neural radiance field based on the views of the target three-dimensional model,
where gradient information generated based on the 3D control voxels is embedded in a backpropagation process for reconstruction of the neural radiance field.

According to one or more embodiments of the present disclosure, a method for generating views of a three-dimensional model is provided. The geometric model includes: one or more non-elementary geometric shapes, or the geometric model is composed of one or more non-elementary geometric shapes.

According to one or more embodiments of the present disclosure, an apparatus for generating views of a three-dimensional model is provided. The apparatus includes:
an obtaining unit configured to obtain a three-dimensional geometric model and a text description; and
a control unit configured to generate views of a target three-dimensional model based on the geometric model and the text description,
where the target three-dimensional model has texture information and the target three-dimensional model conforms to the text description, a similarity between a contour of the target three-dimensional model and a contour of the geometric model is greater than a preset similarity, and the views of the target three-dimensional model include: views corresponding to first camera poses, the number of the first camera poses being one or more.

According to one or more embodiments of the present disclosure, an electronic device is provided. The electronic device includes: at least one memory and at least one processor,
where the at least one memory is configured to store program code, and the at least one processor is configured to call the program code stored in the at least one memory to perform any of the methods described above.

According to one or more embodiments of the present disclosure, a computer-readable storage medium is provided, which is configured to store program code that, when executed by a processor, causes the processor to perform the method described above.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method for generating views of a three-dimensional model, comprising:
obtaining a three-dimensional geometric model and a text description; and
generating views of a target three-dimensional model based on the geometric model and the text description,
wherein the target three-dimensional model has texture information and the target three-dimensional model conforms to the text description, a similarity between a contour of the target three-dimensional model and a contour of the geometric model is greater than a preset similarity, and the views of the target three-dimensional model comprise: views corresponding to first camera poses, the number of the first camera poses being one or more.

2. The method according to claim 1, wherein generating views of the target three-dimensional model that conforms to the text description and has texture based on the geometric model comprises:
generating geometric feature voxels of the geometric model;
determining a target candidate image based on the geometric model and the text description; and
obtaining the views of the target three-dimensional model based on the geometric feature voxels and features of the target candidate image.

3. The method according to claim 2, wherein
determining the target candidate image based on the geometric model and the text description comprises: generating candidate images based on the geometric model and the text description, and determining, in response to input information, the target candidate image based on the input information;
and/or
generating the geometric feature voxels of the geometric model comprises: performing sampling at sampling points on a surface of the geometric model, and voxelizing the sampling points of the geometric model to populate a zero-initialized occupancy grid to obtain the geometric feature voxels;
and/or
performing denoising iteration on a noisy image based on the geometric feature voxels and the features of the target image to obtain the views of the target three-dimensional model, wherein the following steps are performed during each denoising iteration:
performing back-projection and fusion on a target image to obtain multi-view feature voxels;
inputting the geometric feature voxels and the multi-view feature voxels into a 3D adapter to generate 3D control voxels; and
obtaining output images of the current denoising iteration based on the 3D control voxels, the target image, the features of the target candidate image, and the first camera poses,
wherein the target image is an output image of the last denoising iteration process, when denoising iteration is performed for the first time, the target image is the noisy image, and the number of the output images is a plurality, each matching a respective one of a plurality of the first camera poses.

4. The method according to claim 3, wherein
obtaining output images of the current denoising iteration based on the 3D control voxels, the target image, the features of the target candidate image, and the first camera poses comprises: projecting the 3D control voxels to align with the target image to obtain a 2D feature map, and inputting the 2D feature map, the features of the target candidate image, and the first camera poses into a diffusion model to obtain the output images of the current denoising iteration;
and/or
inputting the geometric feature voxels and the multi-view feature voxels into the 3D adapter to generate the 3D control voxels comprises: the 3D adapter performing 3D convolution on the geometric feature voxels to obtain outputs of intermediate layers, and the 3D adapter performing 3D convolution on the multi-view feature voxels and adding the outputs of the intermediate layers in a layered manner to the process of performing 3D convolution on the multi-view feature voxels to obtain the 3D control voxels.

5. The method according to claim 3, wherein the 3D adapter is pre-trained in advance, and one or both of the following are met:
during a pre-training process for the 3D adapter, a training image and a sampling point of a training geometric model are selected as a training sample, Gaussian noise is added to the training image, and the added noise is predicted through a constraint network; and
during the pre-training process, the 3D adapter uses zero convolution to convolve geometric feature voxels of the training geometric model, while freezing other layers of the 3D adapter.

6. The method according to claim 3, wherein after generating the views of the target three-dimensional model based on the geometric model and the text description, the method further comprises:
changing a first part of the text description;
performing a modification operation on a second part of the geometric model that corresponds to the first part to obtain the updated geometric model;
updating the target candidate image based on a second part of the updated geometric model and the first part;
updating the 3D control voxels based on a feature mask of the second part of the updated geometric model to obtain the updated 3D control voxels; and
re-performing the denoising iteration based on the updated 3D control voxels, features of an updated target candidate image, and the first camera poses to obtain views of an updated target three-dimensional model;
or
changing a first part of the text description;
updating the target candidate image based on a second part of the geometric model that corresponds to the first part and the first part;
updating the 3D control voxels based on a feature mask of the second part of the geometric model to obtain the updated 3D control voxels; and
re-performing the denoising iteration based on the updated 3D control voxels, features of an updated target candidate image, and the first camera poses to obtain views of an updated target three-dimensional model;
or
performing a modification operation on a second part of the geometric model to obtain the updated geometric model;
updating the target candidate image based on a second part of the updated geometric model;
updating the 3D control voxels based on a feature mask of the second part of the updated geometric model to obtain the updated 3D control voxels; and
re-performing the denoising iteration based on the updated 3D control voxels, features of an updated target candidate image, and the first camera poses to obtain views of an updated target three-dimensional model.

7. The method according to claim 3, wherein
the 3D control voxels during the denoising iteration are cached; and
the method further comprises: in response to an event of obtaining a view of the target three-dimensional model that corresponds to a second camera pose, performing denoising iteration on the noisy image using the second camera pose and the 3D control voxels cached to obtain the view of the target three-dimensional model that corresponds to the second camera pose.

8. The method according to claim 3, further comprising:
generating the target three-dimensional model using a neural radiance field based on the views of the target three-dimensional model,
wherein gradient information generated based on the 3D control voxels is embedded in a backpropagation process for reconstruction of the neural radiance field.

9. The method according to claim 1, wherein
the geometric model comprises one or more non-elementary geometric shapes, or the geometric model is composed of one or more non-elementary geometric shapes.

10. An electronic device, comprising:
at least one memory and at least one processor,
wherein the at least one memory is configured to store program code, and the at least one processor is configured to call the program code stored in the at least one memory to perform a method for generating views of a three-dimensional model comprising:
obtaining a three-dimensional geometric model and a text description; and
generating views of a target three-dimensional model based on the geometric model and the text description,
wherein the target three-dimensional model has texture information and the target three-dimensional model conforms to the text description, a similarity between a contour of the target three-dimensional model and a contour of the geometric model is greater than a preset similarity, and the views of the target three-dimensional model comprise: views corresponding to first camera poses, the number of the first camera poses being one or more.

11. The electronic device according to claim 10, wherein generating views of the target three-dimensional model that conforms to the text description and has texture based on the geometric model comprises:
generating geometric feature voxels of the geometric model;
determining a target candidate image based on the geometric model and the text description; and
obtaining the views of the target three-dimensional model based on the geometric feature voxels and features of the target candidate image.

12. The electronic device according to claim 11, wherein
determining the target candidate image based on the geometric model and the text description comprises: generating candidate images based on the geometric model and the text description, and determining, in response to input information, the target candidate image based on the input information;
and/or
generating the geometric feature voxels of the geometric model comprises: performing sampling at sampling points on a surface of the geometric model, and voxelizing the sampling points of the geometric model to populate a zero-initialized occupancy grid to obtain the geometric feature voxels;
and/or
performing denoising iteration on a noisy image based on the geometric feature voxels and the features of the target image to obtain the views of the target three-dimensional model, wherein the following steps are performed during each denoising iteration:
performing back-projection and fusion on a target image to obtain multi-view feature voxels;
inputting the geometric feature voxels and the multi-view feature voxels into a 3D adapter to generate 3D control voxels; and
obtaining output images of the current denoising iteration based on the 3D control voxels, the target image, the features of the target candidate image, and the first camera poses,
wherein the target image is an output image of the last denoising iteration process, when denoising iteration is performed for the first time, the target image is the noisy image, and the number of the output images is a plurality, each matching a respective one of a plurality of the first camera poses.

13. The electronic device according to claim 12, wherein
obtaining output images of the current denoising iteration based on the 3D control voxels, the target image, the features of the target candidate image, and the first camera poses comprises: projecting the 3D control voxels to align with the target image to obtain a 2D feature map, and inputting the 2D feature map, the features of the target candidate image, and the first camera poses into a diffusion model to obtain the output images of the current denoising iteration;
and/or
inputting the geometric feature voxels and the multi-view feature voxels into the 3D adapter to generate the 3D control voxels comprises: the 3D adapter performing 3D convolution on the geometric feature voxels to obtain outputs of intermediate layers, and the 3D adapter performing 3D convolution on the multi-view feature voxels and adding the outputs of the intermediate layers in a layered manner to the process of performing 3D convolution on the multi-view feature voxels to obtain the 3D control voxels.

14. The electronic device according to claim 12, wherein the 3D adapter is pre-trained in advance, and one or both of the following are met:
during a pre-training process for the 3D adapter, a training image and a sampling point of a training geometric model are selected as a training sample, Gaussian noise is added to the training image, and the added noise is predicted through a constraint network; and
during the pre-training process, the 3D adapter uses zero convolution to convolve geometric feature voxels of the training geometric model, while freezing other layers of the 3D adapter.

15. The electronic device according to claim 12, wherein after generating the views of the target three-dimensional model based on the geometric model and the text description, the electronic device further comprises:
changing a first part of the text description;
performing a modification operation on a second part of the geometric model that corresponds to the first part to obtain the updated geometric model;
updating the target candidate image based on a second part of the updated geometric model and the first part;
updating the 3D control voxels based on a feature mask of the second part of the updated geometric model to obtain the updated 3D control voxels; and
re-performing the denoising iteration based on the updated 3D control voxels, features of an updated target candidate image, and the first camera poses to obtain views of an updated target three-dimensional model;
or
changing a first part of the text description;
updating the target candidate image based on a second part of the geometric model that corresponds to the first part and the first part;
updating the 3D control voxels based on a feature mask of the second part of the geometric model to obtain the updated 3D control voxels; and
re-performing the denoising iteration based on the updated 3D control voxels, features of an updated target candidate image, and the first camera poses to obtain views of an updated target three-dimensional model;
or
performing a modification operation on a second part of the geometric model to obtain the updated geometric model;
updating the target candidate image based on a second part of the updated geometric model;
updating the 3D control voxels based on a feature mask of the second part of the updated geometric model to obtain the updated 3D control voxels; and
re-performing the denoising iteration based on the updated 3D control voxels, features of an updated target candidate image, and the first camera poses to obtain views of an updated target three-dimensional model.

16. The electronic device according to claim 12, wherein
the 3D control voxels during the denoising iteration are cached; and
the electronic device further comprises: in response to an event of obtaining a view of the target three-dimensional model that corresponds to a second camera pose, performing denoising iteration on the noisy image using the second camera pose and the 3D control voxels cached to obtain the view of the target three-dimensional model that corresponds to the second camera pose.

17. The electronic device according to claim 12, further comprising:
generating the target three-dimensional model using a neural radiance field based on the views of the target three-dimensional model,
wherein gradient information generated based on the 3D control voxels is embedded in a backpropagation process for reconstruction of the neural radiance field.

18. The electronic device according to claim 10, wherein
the geometric model comprises one or more non-elementary geometric shapes, or the geometric model is composed of one or more non-elementary geometric shapes.

19. A computer-readable storage medium configured to store program code that, when executed by a processor, causes the processor to perform a method for generating views of a three-dimensional model comprising:
obtaining a three-dimensional geometric model and a text description; and
generating views of a target three-dimensional model based on the geometric model and the text description,
wherein the target three-dimensional model has texture information and the target three-dimensional model conforms to the text description, a similarity between a contour of the target three-dimensional model and a contour of the geometric model is greater than a preset similarity, and the views of the target three-dimensional model comprise: views corresponding to first camera poses, the number of the first camera poses being one or more.

20. The computer-readable storage medium according to claim 19, wherein generating views of the target three-dimensional model that conforms to the text description and has texture based on the geometric model comprises:
generating geometric feature voxels of the geometric model;
determining a target candidate image based on the geometric model and the text description; and
obtaining the views of the target three-dimensional model based on the geometric feature voxels and features of the target candidate image.
